(19) United States
(12) Patent Application Publication
(10) Pub. No.: US 2018/0132432 A1
(43) Pub. Date: May 17, 2018

(54) Temporary Degradable Plastic Erosion Control Blanket

(71) Applicant: MKB Company, LLC, Groveport, OH (US)

(72) Inventor: Michael A. Zock, Saxonburg, PA (US)

(21) Appl. No.: 15/811,084

(22) Filed: Nov. 13, 2017

Related U.S. Application Data
(60) Provisional application No. 62/421,030, filed on Nov. 11, 2016.

(51) Int. Cl. A01G 13/02; D01F 6/30; D04B 21/10

(52) U.S. Cl. CPC A01G 13/0268; E02B 3/125; D04B 21/10; D01F 6/30

(57) ABSTRACT

A temporary all plastic erosion control blanket is configured to slow water runoff, to provide sediment and erosion control, and to enhance re-vegetation. The temporary all plastic erosion control blanket is fully degradable within less than one year. The temporary all plastic erosion control blanket is a warp knitted structure formed from polyolefin or polyamide materials and includes integral visual stake placement indicia.

### RELATED APPLICATIONS

This application claims priority to U.S. Patent Application Ser. No. 62/421,030 filed Nov. 11, 2016, entitled “Temporary Degradable Plastic Erosion Control Blanket” which is incorporated herein by reference.

### BACKGROUND INFORMATION

### 1. Field of the Invention

The present invention relates to erosion control blankets, and more particularly to degradable erosion control blankets.

### 2. Background Information

For both aesthetic and environmental protection reasons, it is often necessary or desirable to grow ground vegetation, such as grass, on flat land, slopes, channels, and general bare earth areas to inhibit erosion due to the effects of wind and rain. The successful sprouting and growth of ground vegetation planted on these areas, however, is often prevented by the soil erosion which the planted vegetation is designed to inhibit. The erosion may frequently carry away at least some portion of the soil before the vegetation takes hold.

As an attempt to alleviate this problem, it is now a common practice to cover the area with fibrous, mat-like members commonly referred to as erosion control blankets. One well known erosion control blanket is the “Curlex” or excelsior erosion control blanket manufactured and sold by the American Excelsior Company since 1964. This erosion control blanket is fabricated, in elongated rectangular mat form, from elongated, randomly intertwined fiber commonly referred to as “excelsior” or “wood wool” or “aspen fiber.” The fiber mats have historically been held together or contained by photodegradable mesh or netting material, which form nets on one or both sides of the fiber. The erosion control blankets are then conveniently packaged in individually rolled bundles to facilitate their handling and transport to the erosion control job site. The netting or mesh is generally necessary during manufacturing, shipping and the subsequent job site installation in order to maintain the integrity of the excelsior mat.

What has become known as erosion control blankets are usually woven from a chosen material and are used primarily i) to slow water runoff, ii) to provide effective sediment and erosion control, and iii) to enhance re-vegetation. These blankets are commonly applied to channel and ditch linings, slopes, culvert inlets, culvert outfalls, riverbanks, and levees. The material chosen is usually something with lots of ridges and obstructions upon which the runoff water will slow down. The blankets are configured to allow for, and to promote, and/or to accelerate vegetative growth such as through heat retention, moisture retention and erosion control. In addition to the specific type described above, there are many different types of erosion control blankets, some that are synthetic and some that are natural and others that are both synthetic and natural. Conventional blankets can be made out of straw, coconut fiber, aspen fiber, jute, polypropylene (PP) and combinations thereof. Most of these conventional erosion control blankets are available in a variety of sizes. Common sizes include 80 to 100 square yards. Most of these are rolled up and cut into widths ranging from 3 to 12 feet wide.

Erosion control blankets are classified as short term/temporary or long term/permanent use, mostly based on whether vegetation is intended to replace or work in conjunction with the blankets. Within the meaning of this application temporary or short term Erosion Control Blankets are those that remain in position less than 12 months, and they will completely degrade or decompose within that time. Within the meaning of this application long term Erosion Control Blankets are those that remain in position for greater than 12 months. Long term Erosion Control Blankets, within the meaning of this application, include sub sets of semi-permanent and permanent Erosion Control Blankets. Within the meaning of this application semi-permanent Erosion Control Blankets are those that remain in position for 18 to 36 months, and they will completely degrade or decompose within that time. Within the meaning of this application permanent Erosion Control Blankets are those that remain in position for greater than 36 months, and include blankets that are intended to last far longer than this defined limit. Certain applications require a certain class of Erosion Control Blanket and the types, thus, may not be interchangeable. For example, it should be clear that a permanent Erosion Control Blanket cannot be utilized in an application requiring a temporary Erosion Control Blanket and vice versa.

Confusing the issue is that the industry has not always used the same terms to define classes of Erosion Control Blankets. For example, some divide the classes into “short term” blankets, “long term” blankets and “permanent” blankets, in which “long term” is roughly analogous to the semi-permanent blanket as defined herein, however the cut off for “short term” in this alternative definition can extend to 18 or even 24 months and the cut off for “permanent” may be higher than 36 months (e.g. “permanent” may mean the blanket is still present and effective after 5 years). Typically an engineer detailing a job will define the limit or desired duration of the blanket (e.g. the “blanket must be degraded within 18 months and not interfere with grass cutting procedures” or the “blanket should remain for 18-24 months” and it is this time frame that obviously governs, but the engineers may not utilize consistent terms for these time frames as noted above). Whatever the “classification system” different classes of blankets are distinctly different and thus it is important to have a clear understanding of the scope of the classes and the present application will utilize the definitions for the classes defined above.

The following are examples of existing erosion control blankets:

A Jute Netting Erosion Control Blanket 12, a representative illustration of which is shown in FIG. 4, is made from the natural fiber jute and is often used as an erosion control device alone or alternatively used to hold together other erosion control materials

A Fabrijute Netting Erosion Control Blanket 14, a representative illustration of which is shown in FIG. 5, is made entirely from plastic, namely polypropylene (PP), and is intended to generally mimic natural fibers. Netting like this is also used to hold together other materials in a composite erosion control blanket or just as erosion control blanket itself. The Fabrijute Netting Erosion Control Blanket 14 is a long term (>12 months), semi-permanent (18-36 months) or permanent Erosion Control Blanket structure.

A Straw Single Synthetic Erosion Control Blanket 16, a representative illustration of which is shown in FIG. 6, is made from straw and held together by a single layer of synthetic (typically PP) netting. A Straw Double Synthetic Erosion Control Blanket (not shown, but similar to FIG. 6) is made from ordinary straw it is held together by a double layer of synthetic netting

A Straw double jute net Erosion Control Blanket 18, a representative illustration of which is shown in FIG. 7, is made from ordinary straw, and is held together by a double layer of jute netting

A Coir Double Jute Erosion Control Blanket 20, a representative illustration of which is shown in FIG. 8, is made from coconut fiber and it is held together by a double layer of jute netting.

A Coir Double Synthetic Erosion Control Blanket 22, a representative illustration of which is shown in FIG. 9, is made from coconut fiber and it is held together by a double layer of synthetic netting

An Excelsior (Aspen fiber) Single Synthetic Erosion Control Blanket 24, a representative illustration of which is shown in FIG. 10, is made from shredded Aspen and it is held together by a single plastic net

An Excelsior (Aspen fiber) Double Synthetic Erosion Control Blanket 26, a representative illustration of which is shown in FIG. 11, is made from Aspen which is then held together by a double layer of synthetic netting

Conventionally erosion control blankets are relatively easy to install. The largest concern, for a conventional slope application, is making sure the water moves over the top of the blankets and the installer needs to ‘key’ it into the slope by digging a small trench on the top of the slope. In this trench the installer lays the top end of the material into the trench to line it and the edge is folded underneath itself and then it is secured using staples, or stakes. The trench is then generally filled in to the previous soil level. Further the edge of the blanket that is upwind needs to be overlapped underneath the blanket next to it.

The patent literature provides additional background in this field and the following patents are incorporated herein by reference in their entireties.

U.S. Pat. No. 3,517,514 discloses an erosion control blanket made of non-woven fabric of randomly orientated fibers such as PP fibers and natural fibers.

U.S. Pat. No. 3,867,250 discloses an erosion control blanket made of randomly distributing straw into a layer and binding the stalks together at their points of contact with a water resistant adhesive comprising a polymer of an alkenyl aromatic monomer, an open chain conjugated diene and an unsaturated carboxylic monomer blended with a water soluble cellulose ether and with an organo sulfonate.

U.S. Pat. No. 4,353,946 discloses an erosion control blanket made of wood wool fibers retained in a coherent structure with a degradable plastic mesh such that at least some of the fibers interlock with the mesh and other fibers.

U.S. Pat. No. 4,635,576 discloses an erosion control blanket made of wood wool fibers wherein the mat of wood wool being retained as a coherent structure by longitudinal rows of stitching giving the blanket a quilted appearance.

U.S. Pat. No. 5,249,893 discloses an erosion control blanket formed of a scrim or mesh having a lightweight web secured thereto to be utilized by applying the erosion control mat to a soil surface.

U.S. Pat. No. 5,330,828 discloses an erosion control blanket comprised of a mixture of thermo-mechanically processed wood fibers and synthetic fibers.

U.S. Pat. Nos. 5,735,892 and 5,786,281 each disclose a vegetation growth-enhancing erosion control blanket formed from an elongated rectangular excelsior/wood wool mat. The mat is held together with adhesive and a surface pattern is embossed therein.

U.S. Pat. No. 6,855,650 discloses an erosion control blanket featuring a crimped, polyester fiber filler material, such as polyethyleneterephthalate (PET) readily available in post-consumer form from the recycling of soda bottles.

U.S. Pat. No. 7,563,058 discloses a vegetation growth-enhancing erosion control blanket formed from an elongated rectangular excelsior/wood wool mat. The mat is held together with threads stitched therein.

There remains a need in the art for a temporary fully degradable, all plastic erosion control blanket which is effective to slow water runoff, to provide effective sediment and erosion control, and to enhance re-vegetation.

### SUMMARY OF THE INVENTION

The objects of the present invention are achieved with a temporary all plastic erosion control blanket which is configured to slow water runoff, to provide sediment and erosion control, and to enhance re-vegetation, wherein the blanket is fully degradable within less than one year, wherein the blanket is a warp knitted structure formed from polyolefin or polyamide materials and includes integral visual stake placement indicia.

The objects of the present invention are also achieved with a temporary all plastic erosion control blanket which is configured to slow water runoff, to provide sediment and erosion control, and to enhance re-vegetation, wherein the blanket is a warp knitted structure formed from polyolefin or polyamide materials and wherein the polyolefin or polyamide materials additionally include oxi-degradable plastic additives configured to assure complete degradation of the blanket via oxo-degradation within 12 months.

The features that characterize the present invention are pointed out with particularity in the claims which are part of this disclosure. These and other features of the invention, its operating advantages and the specific objects obtained by its use will be more fully understood from the following detailed description in connection with the attached figures.

### BRIEF DESCRIPTION OF THE FIGURES

FIG. 1 is a schematic plan view of a Temporary Degradable Plastic Erosion Control Blanket formed according to one aspect of the present invention;

FIG. 2 is a schematic plan view of a Temporary Degradable Plastic Erosion Control Blanket formed according to one aspect of the present invention; and

FIG. 3 is a perspective view of a Temporary Degradable Plastic Erosion Control Blanket formed according to one aspect of the present invention;

FIG. 4 is a plan view of a portion of a conventional Jute Netting Erosion Control Blanket known in the prior art;

FIG. 5 is a plan view of a portion of a conventional Fabrijute Netting Erosion Control Blanket known in the prior art;

FIG. 6 is a plan view of a portion of a conventional Straw Single Synthetic Erosion Control Blanket known in the prior art;

FIG. 7 is a plan view of a portion of a conventional Straw double jute net Erosion Control Blanket known in the prior art;

FIG. 8 is a plan view of a portion of a conventional Coir Double Jute Erosion Control Blanket known in the prior art;

FIG. 9 is a plan view of a portion of a conventional Coir Double Synthetic Erosion Control Blanket known in the prior art;

FIG. 10 is a plan view of a portion of a conventional Excelsior (Aspen fiber) Single Synthetic Erosion Control Blanket known in the prior art; and

FIG. 11 is a plan view of a portion of a conventional Excelsior (Aspen fiber) Double Synthetic Erosion Control Blanket known in the prior art.

### DESCRIPTION OF THE PREFERRED EMBODIMENTS

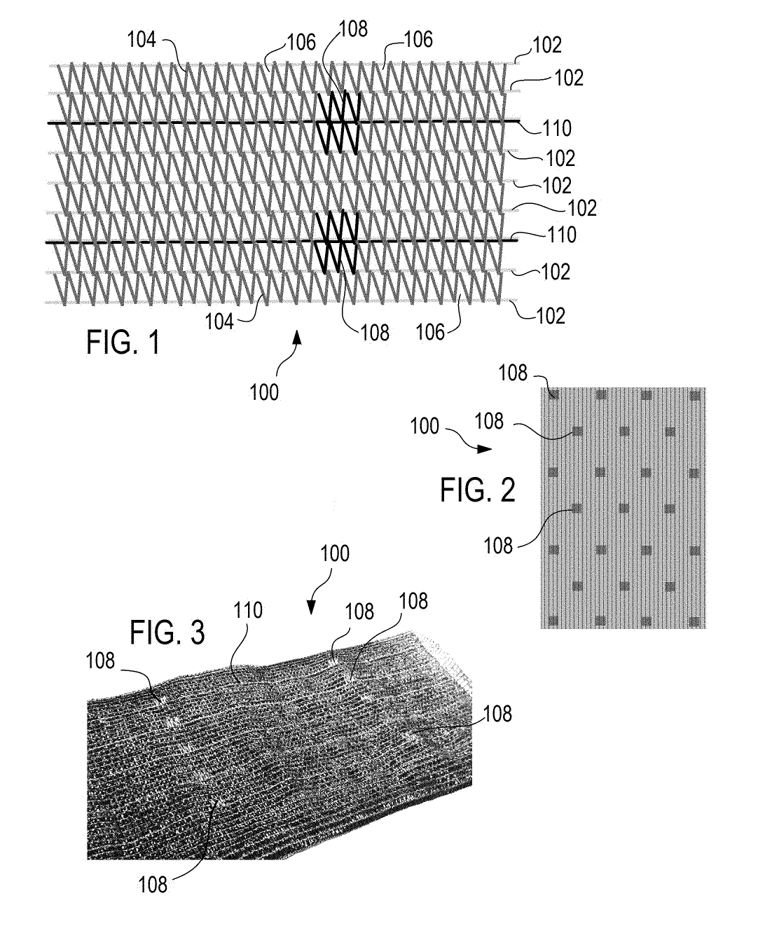

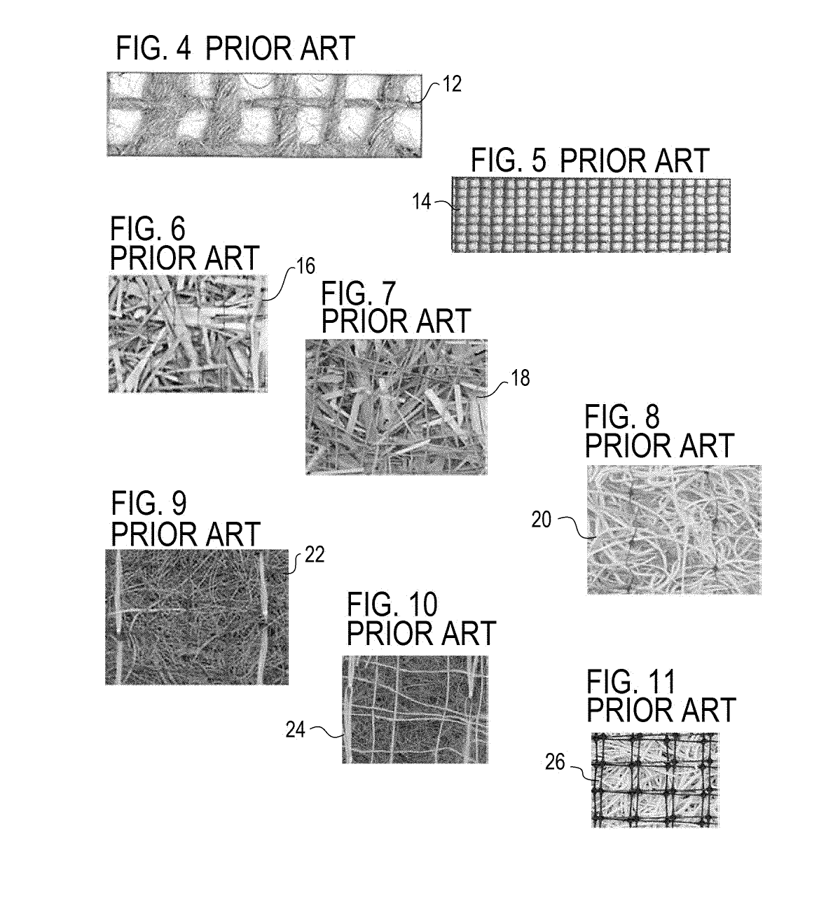

The present invention is temporary all plastic erosion control blanket 100 which is effective to slow water runoff, to provide effective sediment and erosion control, and to enhance re-vegetation which is fully degradable within less than one year. Fully degraded is a known term in the erosion control art relating to blankets and effectively defines that the blanket 100 will no longer be an integrated unit and generally only trace components or remnants of the blanket 100 would be found, if any, after a year. The blanket 100 of the present invention shown in FIGS. 1-3 is preferably a warp knitted structure formed from plastic yarns or materials, such as polyolefin or polyamide materials. Acceptable polyolefin materials include polypropylene (PP) and polyethylene (PE) materials. The polyolefin or polyamide materials, commonly polypropylene, will additionally include oxi-degradable plastic additives, such as those sold by EPI under the TDPA® brand, sufficient to assure complete degradation of the blanket via oxo-degradation within 12 months. The oxidegradable plastic additives sold by EPI under the TDPA® brand are suitable for PE and PP materials. FIG. 1 is a schematic top plan view of the Temporary Degradable Plastic Erosion Control Blanket 100 according to the present invention. Specifically, the Temporary Degradable Plastic Erosion Control Blanket according to the present invention will appear as shown in FIG. 3.

The warp knitted structure of the blanket of the present invention include warp 102 and weft threads 104 wherein the warp threads 102 extend substantially longitudinally along a longitudinal axis of the blanket 100 while the weft threads 104 extend generally perpendicular to the longitudinal axis of the blanket 100. The arrangement of the warp and weft threads is analogous to the arrangement found in the DIAMOND SOCK® brand compost filter sock sold by MKB, and the range of variation of the warp threads 102 from being parallel with the longitudinal axis (substantially longitudinally) or of the weft threads 104 extending generally perpendicular to the longitudinal axis of the blanket within the meaning of the present invention are defined and known in this filter sock netting forming technology. The structure may be effectively formed using warp knitting technology on a RASCHELL Warp Knitted Double Needle Bar Machine. The use of warp knitting technology on a RASCHELL Warp Knitted Double Needle Bar Machine allows effective widths of the blanket 100 of the present invention to be between 4′ and 54′. Preferably the effective widths of the blanket will be 8′ and 16′. As noted above, larger areas can easily have two blankets 100 adjacent each other with one overlapping the other at the edges.

The mesh opening size 106 is significant for a proper erosion control blanket allowing revegetation, as if the openings 106 are too small, namely less than 3/16″ in diameter, the vegetation cannot grow; and if the openings 106 are too big, namely greater than ⅝″ in diameter, then there may be insufficient erosion control and heat and moisture retention. Mesh openings 106 can take many shapes, and thus the true measurement of opening size 106 should be in area terms (i.e. square inches or the like), however custom has been to define openings in mesh with a length measurement which can be considered as an “effective diameter.” The mesh opening size 106 of the blanket 100 of the present invention have an effective diameter of at least 3/16″ and no greater than ⅝″, preferably ⅜″-½″ effective diameter. The warp knitted structure described and shown above yields an elongated triangle for openings that are about ⅜″ long, about 3/16″ wide at the wider end and tapering to about ⅛″ wide at a narrow end of the opening 106 and is quite effective openings for the erosion control blanket 100.

The Temporary Degradable Plastic Erosion Control Blanket 100 according to the present invention can be utilized and placed in a conventional fashion and operate as substantially conventional Temporary Degradable Plastic Erosion Control Blanket 100. The Temporary Degradable Plastic Erosion Control Blanket 100 may be staked in position with stakes driven through the Temporary Degradable Plastic Erosion Control Blanket 100 at spaced locations along the blanket 100 to secure the blanket 100 at a desired location. As described below the blanket of the present invention may have visible indicia 108 integrated into the blanket 108 to indicate the desired location of the stakes and this is schematically in FIG. 2.

FIG. 2 schematically illustrates the integrated visible stake placement indicia 108, also called pinning indicia, in the Temporary Degradable Plastic Erosion Control Blanket 108 according to the present invention. Each integrated visible stake placement indicia in the blanket is formed by a distinctly colored thread 110 (e.g., an orange thread) that follows a warp thread 102 and then inlays back and forth between two adjacent warp threads 102 at the appropriate intervals to form the indicia 108. FIG. 1 shows the indicating thread 110 as thicker solely for illustrative purposes, as in practice a visibly distinct thread 110 of the same general thickness as the warp thread 102 and/or the weft thread 104 can easily form the indicia 108. Warp knitting technology can easily and effectively add distinct visible threads 110 at any location in the netting forming the blanket as known in the art to form the indicia.

The indicia 108 are evenly spaced such that they also serve as a blanket 100 length measurement tool for users and inspectors, separate from stake placement. This allows for inspectors to easily measure the length of an installation without the need to measure on the slope, which can be difficult. Similarly for the users during installation is allows them to quickly measure out the length of blanket 100 needed for a given installation.

The color of the blanket 100, namely the color of the warp 102 and weft threads 104 other than the ones 110 forming the stake indicia 108, can be an important aspect of the invention. The color of the stake indicia 108 threads is also important in that this color must be sufficiently different from the remaining color(s) of the blanket 100 so as to be easily viewable, however the stake indicia 108 color is not the dominant color of the blanket.

The color of the blanket 100 may, in one embodiment, be a green as color match for the grass for aesthetic look minimizing the visibility of the blanket 100 to the public while grass is starting. An alternative color for the blanket 100 is one in which reflected light is of a color to promote the selected vegetation. It is known that certain colors of light will promote certain plant growth. For example blue lights have been found to increase the growth rate of stalks and leaves of certain plants, while red light (possibly combined with blue) has been found to promote the flowering of certain plants. Thus a blue color for the warp and weft threads 102 and 104 may increase the effectiveness of the blanket to stimulate vegetation in certain applications.

The temporary fully degradable, all plastic erosion control blanket 100 according to the present invention is a replacement for existing temporary Rolled Erosion Control Blanketing (RECB). The temporary fully degradable, all plastic erosion control blanket 100 according to the present invention will retain as much moisture in the soil as a Straw Double Synthetic Erosion Control Blanket. Further, the temporary fully degradable, all plastic erosion control blanket 100 according to the present invention will deflect rill cutting energy and prevent rills from flowing water at least as effective as a Straw Double Synthetic Erosion Control Blanket. Further, the temporary fully degradable, all plastic erosion control blanket 100 according to the present invention will deflect heat in sun, and retain heat in cold at least as effective as a Straw Double Synthetic Erosion Control Blanket.

The temporary fully degradable, all plastic erosion control blanket 100 according to the present invention will degrade completely in 12 months via Oxo degradation. Further, the blanket 100 of the present invention will avoid unwanted cross contamination (i.e. it will bring along no extraneous seeds, bacteria, fungus, etc.—unlike straw, coconut, or excelsior blankets). The later treatment of an unwanted weed, bacteria or fungus is time consuming and can set back, or in worst case completely undue, the vegetation efforts.

The blanket 100 of the present invention is degraded or broken down enough to “mulch” into grown grass, if the area is mowed, after three months when the blanket 100 is engaged by the mower. A blanket 100 may be engaged by a mower because the growing vegetation can sometimes lift the blanket to the height of the mower deck. The failure of prior art plastic netting from being capable of being mulched (i.e. defined herein as capable of being sheared by the rotating blades of a conventional mower deck—as opposed to wrapping around the rotor of the mower and possibly clogging the mower) has limited the use of such netting in applications that are subject to mowing during the netting life.

The blanket of the present invention costs less than conventional a Straw Double Synthetic Erosion Control Blankets of the same size, and the present invention is not be caught up in straw shortages and the components making the blanket 100 of the present invention are viewed as a more stable commodity than straw. The blanket 100 of the present invention is 4×-5× denser packaging than conventional Straw Double Synthetic Erosion Control Blankets of the same size, yielding a large shipping advantage to the present invention (and thus lower final cost).

The blanket 100 of the present invention yields a favorable “RUSLE C factor”, which requires some explanation. The Revised Universal Soil Loss Equation (now RUSLE2) estimates soil loss from rill and interrill (sheet and rill) erosion caused by rainfall and its associated overland flow. RUSLE2 uses six factors including climatic erosivity, soil erodibility, slope length, slope steepness, cover management, and support practices to compute soil loss. The USDA-Agricultural Research Service (ARS) is the lead research agency that developed RUSLE2. The structure of the revised universal soil loss equation RUSLE2 is based on the Universal Soil Loss Equation (USLE), which is given by: A=R K L S C P where A=average annual soil loss from rill and interrill erosion caused by rainfall and its associated overland flow (tons ac-1 yr-1), R=the factor for climatic erosivity, K=the factor for soil erodibility measured under a standard condition, L=the factor for slope length, S=the factor for slope steepness, C=the factor for cover-management, and P=the factor for support practices. A value for soil loss A is computed by selecting values for each factor and multiplying them. These factors represent the effect of climate, soil, topography, and land use on rill and interrill erosion. By assigning values to these factors based on site-specific conditions, the rule is a widely accepted computation of soil loss for specific sites, and is used to guide conservation planning tailored to individual field sites.

The RUSLE C factor is the most common factor used to assess the impact of BMPs on reducing erosion because the RUSLE C factor represents the effect of land use on soil erosion (See Renard, K. G., G. R. Foster, G. A. Weesies, D. K. McCool, and D. C. Yoder. 1997. Predicting Soil Erosion by Water: A Guide to Conservation Planning with the Revised Universal Soil Loss Equation—USDA Agric. Handb. 703. U.S. Gov. Print. Office, Washington, D.C.). Erosion control blankets and surface applied BMPs such as blown straw are represented as C factors within RUSLE. By definition, C=1 under standard fallow conditions. As surface cover is added to the soil, the C factor value approaches zero. For example, a C factor of 0.20 signifies that 20% of the amount of erosion will occur compared to continuous fallow conditions. C factors vary from region to region because they are strongly influenced by different R factors (see Wischmeier, W. H., and D. D. Smith. 1978. Predicting Rainfall Erosion Losses: A Guide For Conservation Planning—USDA Agric. Handb. 537. U.S. Gov. Print. Office, Washington, D.C.). The blanket 100 of the present invention yields a favorable RUSLE C factor, at least as it relates to reducing soil loss. The specific C factor will vary upon soil type and other site specific issues, as discussed above, but the blanket 100 of the present invention yields a favorable RUSLE C factor, specifically one which is less than or equal to the RUSLE C factor of conventional Straw Double Synthetic Erosion Control Blankets.

While the invention has been shown in several particular embodiments it should be clear that various modifications may be made to the present invention without departing from the spirit and scope thereof. The scope of the present invention is defined by the appended claims and equivalents thereto.

What is claimed is:

1. A temporary all plastic erosion control blanket which is configured to slow water runoff, to provide sediment and erosion control, and to enhance re-vegetation, wherein the blanket is fully degradable within less than one year, wherein the blanket is a warp knitted structure formed from polyolefin or polyamide materials and includes integral visual stake placement indicia.

2. The temporary all plastic erosion control blanket according to claim 1 wherein the blanket is a warp knitted structure formed from polyolefin materials including polypropylene (PP) and polyethylene (PE) materials.

3. The temporary all plastic erosion control blanket according to claim 1 wherein the polyolefin or polyamide materials additionally include oxi-degradable plastic additives configured to assure complete degradation of the blanket via oxo-degradation within 12 months.

4. The temporary all plastic erosion control blanket according to claim 1 wherein the blanket is configured for formation via warp knitting technology on a RASCHELL Warp Knitted Double Needle Bar Machine.

5. The temporary all plastic erosion control blanket according to claim 1 wherein the blanket has a width of between 8′ and 16′.

6. The temporary all plastic erosion control blanket according to claim 1 wherein the blanket includes mesh opening sizes having an effective diameter of at least 3/16″ and no greater than ⅝″.

7. The temporary all plastic erosion control blanket according to claim 1 wherein the blanket includes mesh opening sizes having an effective diameter of at least ⅜″ and no greater than ½″.

8. The temporary all plastic erosion control blanket according to claim 1 wherein the blanket includes a warp knitted structure which yields an elongated triangle for openings that are about ⅜″ long, about 3/16″ wide at the wider end and tapering to about ⅛″ wide at a narrow end.

9. The temporary all plastic erosion control blanket according to claim 1 wherein the integrated visible stake placement indicia in the blanket is formed by a distinctly colored thread that follows a warp thread and then inlays back and forth between two adjacent warp threads at the appropriate intervals to form the indicia.

10. The temporary all plastic erosion control blanket according to claim 1 wherein the integrated visible stake placement indicia are evenly spaced such that they also serve as a blanket length measurement tool.

11. The temporary all plastic erosion control blanket according to claim 1 wherein the blanket is configured to be degraded to be mulched after three months when the blanket is engaged by a mower.

12. The temporary all plastic erosion control blanket according to claim 1 wherein the blanket yields a RUSLE C factor which is less than or equal to the RUSLE C factor of conventional Straw Double Synthetic Erosion Control Blankets.

13. A temporary all plastic erosion control blanket which is configured to slow water runoff, to provide sediment and erosion control, and to enhance re-vegetation, wherein the blanket is a warp knitted structure formed from polyolefin or polyamide materials and wherein the polyolefin or polyamide materials additionally include oxi-degradable plastic additives configured to assure complete degradation of the blanket via oxo-degradation within 12 months.

14. The temporary all plastic erosion control blanket according to claim 13 wherein the blanket is configured to be degraded to be mulched after three months when the blanket is engaged by a mower.

15. The temporary all plastic erosion control blanket according to claim 13 further including integrated visible stake placement indicia, wherein the integrated visible stake placement indicia in the blanket is formed by a distinctly colored thread that follows a warp thread and then inlays back and forth between two adjacent warp threads at the appropriate intervals to form the indicia.

16. The temporary all plastic erosion control blanket according to claim 15 wherein the integrated visible stake placement indicia are evenly spaced such that they also serve as a blanket length measurement tool.

17. The temporary all plastic erosion control blanket according to claim 13 wherein the blanket includes a warp knitted structure which yields an elongated triangle for openings that are about ⅜″ long, about 3/16″ wide at the wider end and tapering to about ⅛″ wide at a narrow end.

18. The temporary all plastic erosion control blanket according to claim 13 wherein the blanket is a warp knitted structure formed from polyolefin materials including polypropylene (PP) and polyethylene (PE) materials.

19. The temporary all plastic erosion control blanket according to claim 13 wherein the blanket has a width of between 8′ and 16′.

20. The temporary all plastic erosion control blanket according to claim 13 wherein the blanket yields a RUSLE C factor which is less than or equal to the RUSLE C factor of conventional Straw Double Synthetic Erosion Control Blankets.
